(19) United States
(12) Patent Application Publication
(10) Pub. No.: US 2017/0176634 A1
(43) Pub. Date: Jun. 22, 2017

(54) Neutron Gamma Density Fast Neutron Correction Using A Direct Fast Neutron Detector

(71) Applicant: SCHLUMBERGER TECHNOLOGY CORPORATION, Sugar Land, TX (US)

(72) Inventor: Michael Lynn Evans, Missouri City, TX (US)

(21) Appl. No.: 14/974,135

(22) Filed: Dec. 18, 2015

(51) Int. Cl. G01V 5/10

(52) U.S. Cl. CPC G01V 5/101

(57) ABSTRACT

Methods and devices for determining accurate neutron-gamma density (NGD) measurements of a broad range of formations. The NGD measurements may be obtained by emitting neutrons into a formation such that some of the neutrons inelastically scatter off elements of the formation and generate inelastic gamma rays. Inelastic gamma rays that return to the downhole tool may be detected. Additionally, fast neutron signals may be directly measured with a fast neutron detector. Some characteristics of certain formations are believed to affect the fast neutron transport of the formations. Thus, if a formation has one or more of such characteristics, a correction may be applied to a count rate of inelastic gamma rays from which the neutron-gamma density (NGD) may be determined.

### BACKGROUND

This disclosure relates generally to neutron-gamma density (NGD) well logging and, more particularly, to techniques for obtaining an accurate NGD measurement in certain formations using a correction factor based on measurements from a fast neutron detector.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of any kind.

Techniques have been developed to generate gamma rays for a formation density measurement without radioisotopic gamma ray sources. One such technique is referred to as a neutron-gamma density (NGD) measurement. An NGD measurement involves emitting neutrons into the formation using a neutron source, such as a neutron generator. Some of these neutrons may inelastically scatter off certain elements in the formation, generating inelastic gamma rays that may enable a formation density determination. Although an NGD measurement based on these gamma rays may be accurate in some formations, the NGD measurement may be less accurate in other formations.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Embodiments of the disclosure relate to a method including emitting neutrons into a formation using a neutron source of a downhole so that part of the neutrons inelastically scatter off the formation and generate inelastic gamma rays. Additionally, the method includes detecting a count rate of inelastic gamma rays using a gamma ray detector of the downhole tool and directly measuring a fast neutron signal with a fast neutron detector of the downhole tool. The fast neutron signal may vary depending on a neutron transport characteristic of the formation. Further, the method includes determining whether the neutron transport characteristic of the formation is expected to cause a count rate of neutrons to result in a neutron gamma density determination that is not accurate without a fast neutron correction. The fast neutron correction is not applied when the neutron transport characteristic is not expected to cause the count rate of neutrons to result in the neutron gamma density determination that is not accurate without the fast neutron correction. Furthermore, when the formation has the neutron transport characteristic that is expected to cause the count rate of neutrons to result in the neutron gamma density determination that is not accurate without the fast neutron correction, the method includes applying the fast neutron correction to the count rate of inelastic gamma rays, a neutron transport correction function, or both. The method also includes determining a density of the formation based at least in part on the corrected count rate of inelastic gamma rays, the corrected neutron transport correction function, or both and outputting the determined density of the formation.

The fast neutron detector comprises a He-4 fast neutron detector. However, any other appropriate fast neutron detector may be used.

The method may comprise determining whether the neutron transport characteristic of the formation is expected to cause the count rate of fast neutrons to result in the neutron gamma density determination that is not accurate without the fast neutron correction comprises determining whether the formation comprises a concentration of light or heavy elements beyond a predetermined threshold and/or determining whether a measured value of the fast neutron count rate is outside a predetermined range.

Determining whether the measured fast neutron count rate is outside the predetermined range may comprises determining a non-corrected density based on a non-corrected measured count rate of inelastic gamma rays and a non-corrected neutron transport correction function; and comparing the measured value of the fast neutron count rate to an expected value of the fast neutron count rate of a formation having the non-corrected density that is expected to cause the count rate of fast neutrons to result in the neutron gamma density determination that is accurate. In the latter case, applying the fast neutron correction may comprise using a correction function depending on the difference between the measured value of the fast neutron count rate and the expected value of fast neutron count rate. In particular, it may comprise determining the difference between the measured value of the fast neutron count rate and the expected value of the fast neutron count rate; determining a correction factor based on the correction function and the determined difference, and correcting with the correction factor the count rate of inelastic gamma rays, the neutron transport correction function, or both.

The method may comprise performing iteratively:
determining whether the neutron transport characteristic of the formation is expected to cause the count rate of fast neutrons to result in the neutron gamma density determination that is not accurate without the fast neutron correction,
when the formation has the neutron transport characteristic that is expected to cause the count rate of fast neutrons to result in the neutron gamma density determination that is not accurate without the fast neutron correction:
   applying the fast neutron correction to the count rate of an inelastic gamma rays, a neutron transport correction function, or both;
   determining a density of the formation based at least in part on the corrected count rate of inelastic gamma rays, the neutron transport correction function, or both;
      an n^{th} corrected density determined from an n^{th} iteration being used to determine whether the neutron gamma density is accurate in an (n+1)^{th} iteration, and outputting the determined density comprises outputting the density determined at the n^{th} iteration.

When the neutron transport characteristic is not expected to cause the count rate of fast neutrons to result in the neutron gamma density determination that is not accurate without the fast neutron correction, determining the density of the formation may be based at least in part on the count rate of inelastic gamma rays without correction, a neutron transport function without correction, or both.

The density of the formation may be determined at least based on the inelastic gamma-ray count rate, the fast neutron count rate, and the neutron transport function. In particular, the density of the formation may be determined based at least in part on the following relationship:

$$\frac{log ( {CR}_{γ}^{inel} ) - f ( {CR}_{neutron} ) - log ( {C}_{cal} \cdot {N}_{S} )}{{c}_{1}} = {ρ}_{electron} ,$$

where ρ_{electron} represents the density of the formation, CR_{y}^{inel} represents the count rate of inelastic gamma rays, CRₙₑᵤₜᵣₒₙ represents the count rate of fast neutrons, ƒ(CRₙₑᵤₜᵣₒₙ) represents the neutron transport correction function, C_{cal} represents a calibration constant, N_{S} represents an output of the neutron source, and c₁ represents a coefficient obtained experimentally or through nuclear modeling, or by a combination thereof.

In another example, a downhole tool includes a neutron source that emits neutrons into a formation at an energy sufficient to cause at least a portion of the neutrons to inelastically scatter off elements of the formation, generating inelastic gamma rays. The downhole tool also includes a gamma ray detector that detects a count rate of inelastic gamma rays that scatter through the formation to reach the downhole tool. Further, the downhole tool includes a fast neutron detector that determines a count rate of fast neutrons, and the fast neutron detector directly measures a fast neutron signal that varies depending on a fast neutron transport characteristic of the formation. Furthermore, the downhole tool includes data processing circuitry that determines whether the neutron transport characteristic of the formation is expected to cause the second count rate of fast neutrons to result in a neutron gamma density determination that is not accurate without a fast neutron correction. The fast neutron correction is not applied when the neutron transport characteristic is not expected to cause the count rate of neutrons to result in the neutron gamma density determination that is not accurate without the fast neutron correction. Additionally, when the formation has the neutron transport characteristic that is expected to cause the count rate of neutrons to result in the neutron gamma density determination that is not accurate without the fast neutron correction, the data processing circuitry: applies the fast neutron correction to the count rate of inelastic gamma rays, a neutron transport correction function, or both; determines a density of the formation based at least in part on a corrected count rate of inelastic gamma rays, corrected neutron transport correction function, or both; and outputs the determined density of the formation.

The fast neutron detector may comprise a He-4 fast neutron detector for instance.

The neutron source may be a pulsed neutron generator.

The downhole tool may also comprise a logging while drilling configuration. Any other configuration, such as wireline configuration, slickline configuration may also be provided for the tool.

In another example, a non-transitory computer readable medium includes executable instructions which, when executed by a processor, cause the processor to instruct a neutron source to emit neutrons into a formation at an energy sufficient to cause at least a portion of the neutrons to inelastically scatter off elements of the formation, generating inelastic gamma rays. Further, the instructions instruct a gamma ray detector to detect a count rate of inelastic gamma rays that scatter through the formation to reach the downhole tool. Additionally, the instructions instruct a fast neutron detector that determines a count rate of fast neutrons to directly measure a fast neutron signal that varies depending on a fast neutron transport characteristic of the formation. Furthermore, the instructions determine whether the neutron transport characteristic of the formation is expected to cause the second count rate of fast neutrons to result in a neutron gamma density determination that is not accurate without a fast neutron correction. The fast neutron correction is not applied when the neutron transport characteristic is not expected to cause the count rate of neutrons to result in the neutron gamma density determination that is not accurate without the fast neutron correction. Additionally, when the formation has the neutron transport characteristic that is expected to cause the count rate of neutrons to result in the neutron gamma density determination that is not accurate without the fast neutron correction, the instructions: apply the fast neutron correction to the count rate of inelastic gamma rays, a neutron transport correction function, or both; determine a density of the formation based at least in part on a corrected count rate of inelastic gamma rays, corrected neutron transport correction function, or both; and output the determined density of the formation.

Technical effects of the present disclosure include the accurate determination of a neutron-gamma density (NGD) measurement for a broad range of formations, including formations with light or heavy elements. These NGD measurements may remain accurate even when the configuration of a downhole tool used to obtain the neutron count rates and gamma ray count rates used in the NGD measurement does not have an optimal configuration. Further, there is no need to dispose the fast neutron detector in the tool in an optimal configuration either to assess the need of applying the correction or not. Thus, an accurate NGD measurement still may be obtained using the systems and techniques disclosed above while enabling a flexible architecture of the tool and in particular of the arrangement of detectors.

Various refinements of the features noted above may be undertaken in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a schematic diagram of a wellsite system employing a neutron-gamma density (NGD) system, in accordance with an embodiment;

FIG. 2 is a schematic section view representing an NGD system capable of accurately measuring density in a formation that includes light or heavy elements, in accordance with an embodiment;

FIG. 3 is a schematic section view representing the NGD system of FIG. 2 in a well-logging operation, in accordance with an embodiment, wherein the plane of the section view in perpendicular to the plane of section view of FIG. 2;

FIG. 4 is a flowchart describing an embodiment of a method for carrying out the well-logging operation of FIG. 3;

FIG. 5 is a crossplot comparing known formation density against formation density obtained without correcting neutron or gamma ray count rates, in accordance with an embodiment;

FIG. 6 is a plot modeling a comparison between an He-4 reaction rate and electron density, in accordance with an embodiment; and

FIG. 7 is a plot modeling a comparison between a fast neutron correction ratio and effective density, in accordance with an embodiment.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Embodiments of this disclosure relate to systems and techniques for obtaining a neutron-gamma density (NGD) measurement that is accurate for various formations including formations with light or heavy elements. In general, a downhole tool for obtaining such an NGD measurement may include a neutron source, at least one neutron detector, and two gamma ray detectors. While the downhole tool is within a borehole of a formation, the neutron source may comprise a pulsed neutron generator emitting fast neutrons of at least 2 MeV into the formation for a brief period of time, referred to herein as a “burst gate,” during which the neutrons may inelastically scatter off certain elements in the formation (e.g., oxygen) to generate gamma rays. The gamma ray detectors of the downhole tool may detect these inelastic gamma rays. The NGD measurement of the formation may be a function of a count rate of these inelastic gamma rays, corrected by a neutron transport correction function based on a neutron count rate from the neutron detector(s). Such a neutron transport correction function generally may accurately account for the neutron transport of most formations commonly encountered in an oil and/or gas well, resulting in an accurate NGD measurement. As used herein, an “accurate” NGD measurement may refer to an NGD measurement that is within about 0.03 g/cc the true density of a formation.

It is believed that neutron counts from some downhole tool configurations may not accurately account for fast neutron transport in certain formations. For instance, when the downhole tool does not include a fast neutron detector, thermal or epithermal neutron detectors may be used to estimate the fast neutron distribution, but count rates from thermal or epithermal neutron detectors may not always accurately reflect the fast neutron transport of some formations in the same way a fast neutron detector would. Moreover, the placement of such thermal, epithermal, and/or fast neutron detectors in the downhole tool may involve a variety of considerations for NGD, as well as many other well logging measurements. As such, some of these thermal or epithermal detectors may not be at a location within the downhole tool that is best suited to detect count rates of neutrons so as to accurately reflect the neutron transport of some formations, when applied in a neutron transport correction function. These situations may arise when an NGD measurement is obtained in certain formations including formations with light or heavy elements beyond some concentration limit.

The nature of these formations will now be briefly described. As used herein, the term “formation with heavy elements” refers to a formation with a concentration of elements of atomic mass of 26 or greater (e.g., shales containing high concentrations of iron or aluminum) beyond a concentration limit. The term “formation with light elements” refers to a formation with a concentration of elements of atomic mass less than 14 (e.g., gas, for instance CH₄) beyond a concentration limit.

According to embodiments of the present disclosure, when an NGD measurement is obtained in a formation, having characteristics that detectably affect the fast neutron transport in a way that differs from other formations, the gamma ray count rate(s) used for the NGD measurement and/or a neutron transport correction function may be modified to more accurately account for the fast neutron transport of the formation. These or any other suitable corrections may be applied when the formation has one or more characteristics that are expected to cause the count rate of neutrons and/or neutron-induced gamma rays not to accurately correspond to a fast neutron transport of the formation, when the count rate of neutrons and/or gamma rays is applied in a neutron transport correction function.

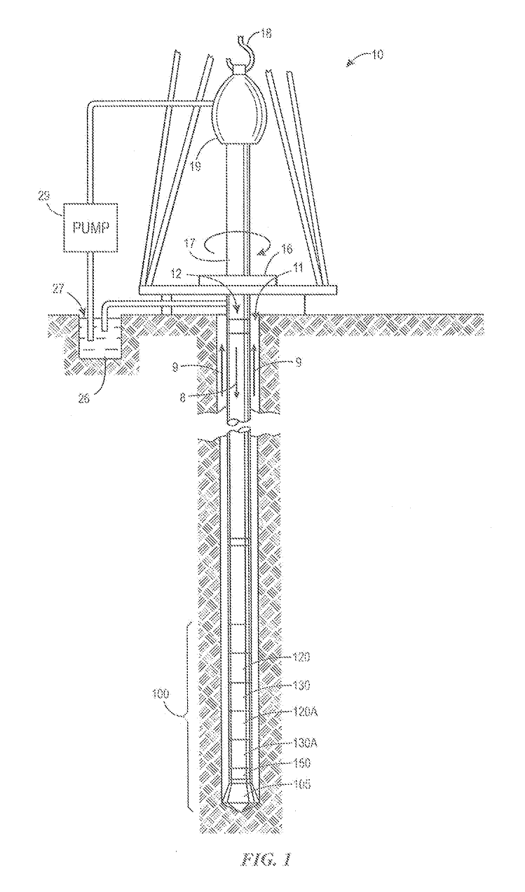

With the foregoing in mind, FIG. 1 illustrates a wellsite system in which the disclosed NGD system can be employed. The wellsite system of FIG. 1 may be onshore or offshore. In the wellsite system of FIG. 1, a borehole 11 may be formed in subsurface formations by rotary drilling using any suitable technique. A drill string 12 may be suspended within the borehole 11 and may have a bottom hole assembly 100 that includes a drill bit 105 at its lower end. A surface system of the wellsite system of FIG. 1 may include a platform and derrick assembly 10 positioned over the borehole 11, the platform and derrick assembly 10 including a rotary table 16, kelly 17, hook 18 and rotary swivel 19. The drill string 12 may be rotated by the rotary table 16, energized by any suitable means, which engages the kelly 17 at the upper end of the drill string 12. The drill string 12 may be suspended from the hook 18, attached to a traveling block (not shown), through the kelly 17 and the rotary swivel 19, which permits rotation of the drill string 12 relative to the hook 18. A top drive system could alternatively be used, which may be a top drive system well known to those of ordinary skill in the art.

In the wellsite system of FIG. 1, the surface system may also include drilling fluid or mud 26 stored in a pit 27 formed at the well site. A pump 29 may deliver the drilling fluid 26 to the interior of the drill string 12 via a port in the swivel 19, causing the drilling fluid to flow downwardly through the drill string 12 as indicated by the directional arrow 8. The drilling fluid 26 may exit the drill string 12 via ports in the drill bit 105, and circulating upwardly through the annulus region between the outside of the drill string 12 and the wall of the borehole 11, as indicated by the directional arrows 9. In this way, the drilling fluid 26 lubricates the drill bit 105 and carries formation cuttings up to the surface, as the fluid 26 is returned to the pit 27 for recirculation.

The bottom hole assembly 100 of the wellsite system of FIG. 1 may include a logging-while-drilling (LWD) module 120 and/or a measuring-while-drilling (MWD) module 130, a roto-steerable system and motor 150, and the drill bit 105. The LWD module 120 can be housed in a special type of drill collar, as is known in the art, and can contain one or more types of logging tools. It will also be understood that more than one LWD module can be employed, as generally represented at numeral 120A. As such, references to the LWD module 120 can alternatively mean a module at the position of 120A as well. The LWD module 120 may include capabilities for measuring, processing, and storing information, as well as for communicating with surface equipment. The LWD module 120 may be employed to obtain a neutron-gamma density (NGD) measurement, as will be discussed further below.

The MWD module 130 can also be housed in a special type of drill collar, as is known in the art, and can contain one or more devices for measuring characteristics of the drill string and drill bit. It will also be understood that more than one MWD can be employed, as generally represented at numeral 130A. As such, references to the MWD module 130 can alternatively mean a module at the position of 130A as well. The MWD module 130 may also include an apparatus for generating electrical power to the downhole system. Such an electrical generator may include, for example, a mud turbine generator powered by the flow of the drilling fluid, but other power and/or battery systems may be employed additionally or alternatively. In the wellsite system of FIG. 1, the MWD module 130 may include one or more of the following types of measuring devices: a weight-on-bit measuring device, a torque measuring device, a vibration measuring device, a shock measuring device, a stick slip measuring device, a direction measuring device, and/or an inclination measuring device.

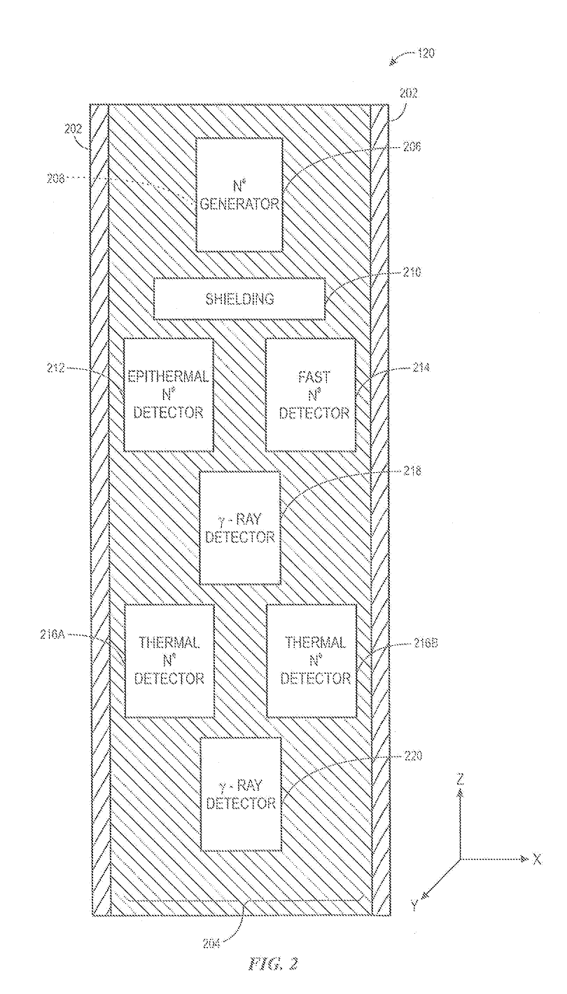

The LWD module 120 may be used in a neutron-gamma density (NGD) system, as shown in FIG. 2, which can accurately measure a density in various types of formations including formations with light or heavy elements. It may be understood that the LWD module 120 is intended to represent one example of a general configuration of an NGD tool, and that other suitable NGD tools may include more or fewer components and may be configured for other means of conveyance. Indeed, other embodiments of NGD tools employing the general configuration of the LWD module 120 are envisaged for use with any suitable means of conveyance, such as wireline, coiled tubing, logging while drilling (LWD), and so forth. By way of example, the LWD module 120 may represent a model of the EcoScope™ tool by Schlumberger.

The LWD module 120 may be contained within a drill collar 202 that encircles a chassis 204 and a mud channel 205. The chassis 204 may include a variety of components used for emitting and detecting radiation to obtain an NGD measurement. For example, a neutron generator 206 may serve as a neutron source that emits neutrons of at least 2 MeV, which is believed to be approximately the minimum energy to create gamma rays through inelastic scattering with formation elements. By way of example, the neutron generator 206 may be an electronic neutron source, such as a Minitron™ by Schlumberger Technology Corporation, which may produce pulses of neutrons through deuteron-deuteron (d-D) and/or deuteron-triton (d-T) reactions. Thus, the neutron generator 206 may emit neutrons around 2 MeV or 14 MeV, for example. A neutron monitor 208 may monitor the neutron emissions from the neutron generator 206. By way of example, the neutron monitor 208 may be a plastic scintillator and photomultiplier that primarily detects unscattered neutrons directly emitted from the neutron generator 206, and thus may provide a count rate signal proportional to the neutron output rate from the rate of neutron output of the neutron generator 206. Neutron shielding 210, which may include lead, for example, may largely prevent neutrons from the neutron generator 206 from passing internally through the LWD module 120 toward various radiation-detecting components on the other side of the shielding 210.

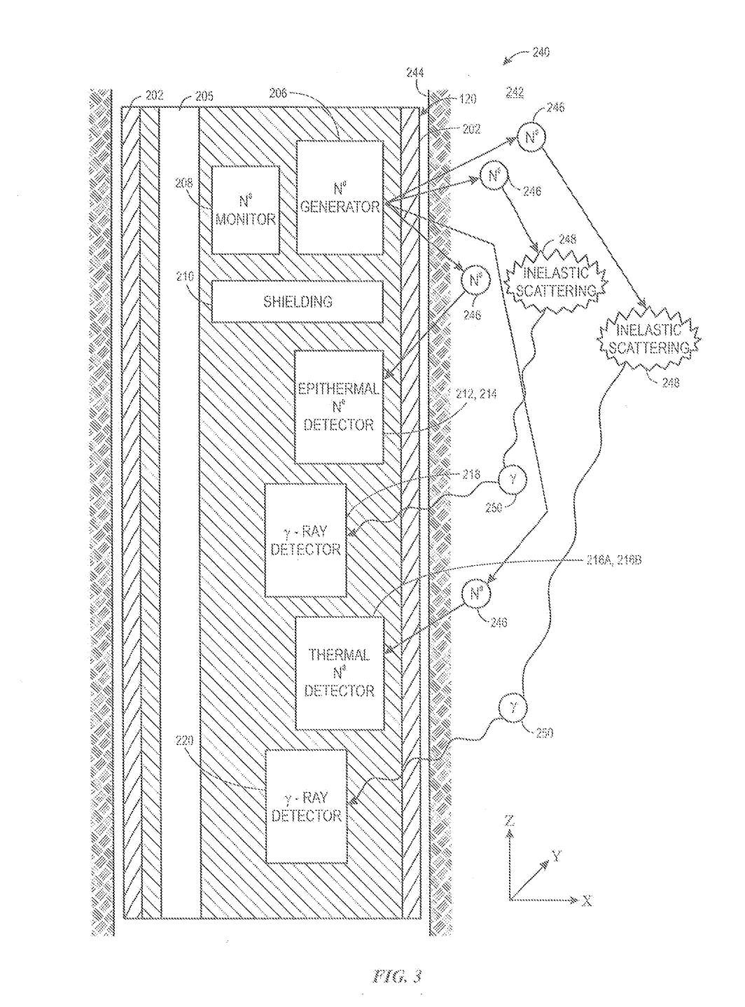

As illustrated in FIGS. 2 and 3, the LWD module 120 may include two near neutron detectors, namely, an epithermal neutron detector 212 and a fast neutron detector 214. Two far thermal neutron detectors 216A and 216B may be located at a spacing farther from the neutron generator 206 than the neutron detectors 212 and 214. For example, the near neutron detectors 212 and 214 may be spaced approximately 10-14 in. from the neutron generator 206, and the far neutron detectors 216A and 216B may be spaced 18-28 in. from the neutron generator 206. A short spacing (SS) gamma ray detector 218 may be located between the near neutron detectors 212 and 214 and the far neutron detectors 216A and 216B. A long spacing (LS) gamma ray detector 220 may be located beyond the far neutron detectors 216A and 216B, at a spacing farther from the neutron generator 206 than the gamma ray detector 218. For example, the SS gamma ray detectors 218 may be spaced approximately 16-22 in. from the neutron generator 206, and the LS gamma ray detector 220 may be spaced approximately 30-38 in. from the neutron generator 206. Alternative embodiments of the LWD module 120 may include more or fewer of such radiation detectors, but generally may include at least two gamma ray detectors and at least one fast neutron detector. For instance, the fast neutron detector may be a long spacing (LS) detector. The tool may also comprise one or more SS or LS neutron detectors, such as an additional thermal neutron detector. Configurations in which the tool comprises fewer detectors than in the embodiment of FIGS. 2 and 3 are also included in the scope of the present disclosure. The neutron detectors 212, 216A, and/or 216B may be any suitable neutron detectors. Additionally, the fast neutron detector 214 may be any suitable fast neutron detector, such as a He-4 fast neutron detector. Other types of fast neutron detector, such as a plastic scintillation detector, may be used as well. Moreover, in formations with heavy elements, such as shales with high concentrations of iron or aluminum, the fast neutron detector 214 may generally provide a direct measurement for neutron flux that accurately reflects the fast neutron transport of such formations.

Additionally, the gamma ray detectors 218 and/or 220 may be scintillator detectors surrounded by neutron shielding. The neutron shielding may include, for example, ⁶Li, such as lithium carbonate (Li₂CO₃), which may substantially shield the gamma ray detectors 218 and/or 220 from thermal neutrons without producing thermal neutron capture gamma rays. The gamma ray detectors 218 and 220 may detect inelastic gamma rays generated when fast neutrons from the neutron generator 206 inelastically scatter off certain elements of a surrounding formation. As will be discussed below, a neutron-gamma density (NGD) measurement may be a function of the inelastic gamma ray counts obtained from the gamma ray detectors 218 and 220, corrected for the fast neutron transport of the formation by the direct measurement of neutron flux obtained from the fast neutron detector 214. Using the direct measurement of the fast neutron flux may avoid relying on an inelastic neutron count rate that dominates a fast neutron correction calculation that uses multiple inputs for computation. Using the systems and techniques disclosed herein, such an NGD measurement may provide enhanced accuracy to the system regardless of whether the formation is a formation with a high concentration of light or heavy elements or a formation that has one or more characteristics that may cause the count rate of neutrons not to accurately correspond to a fast neutron transport of the formation.

The count rates of gamma rays from the gamma ray detectors 218 and 220 and count rates of neutrons from the neutron detectors 212, 214, 216A, and/or 216B may be received by the data processing circuitry 200 as data 222. The data processing circuitry 200 may receive the data 222 and perform certain processing to determine one or more properties of the surrounding formation, such as formation density. The data processing circuitry 200 may include a processor 224, memory 226, and/or storage 228. The processor 224 may be operably coupled to the memory 226 and/or the storage 228 to carry out the presently disclosed techniques. These techniques may be carried out by the processor 224 and/or other data processing circuitry based on certain instructions executable by the processor 224. Such instructions may be stored using any suitable article of manufacture, which may include one or more tangible, computer-readable media to at least collectively store these instructions. The article of manufacture may include, for example, the memory 226 and/or the nonvolatile storage 228. The memory 226 and the nonvolatile storage 228 may include any suitable articles of manufacture for storing data and executable instructions, such as random-access memory, read-only memory, rewriteable flash memory, hard drives, and optical disks.

The LWD module 120 may transmit the data 222 to the data processing circuitry 200 via, for example, internal connections within the tool, a telemetry system communication uplink, and/or a communication cable. The data processing circuitry may be situated in the tool and/or at the surface. The data processing circuitry 200 may determine one or more properties of the surrounding formation. By way of example, such properties may include a neutron-gamma density (NGD) measurement of the formation. Thereafter, the data processing circuitry 200 may output a report 230 indicating the NGD measurement of the formation. The report 230 may be stored in memory or may be provided to an operator via one or more output devices, such as an electronic display.

As shown in a neutron-gamma density (NGD) well-logging operation 240 of FIG. 3, the LWD module 120 may be used to obtain a neutron-gamma density (NGD) measurement that remains accurate in a variety of formations 242. As seen in FIG. 3, the NGD well-logging operation 240 may involve lowering the LWD module 120 into the formation 242 through a borehole 244. In the example of FIG. 3, the LWD module 120 can be lowered into the borehole 244 while drilling, and thus no casing may be present in the borehole 244. However, in other embodiments, a casing may be present. Although such casing could attenuate a gamma-gamma density tool that utilized a gamma ray source instead of a neutron generator 206, the presence of casing on the borehole 244 will not prevent the determination of an NGD measurement because neutrons 246 emitted by the neutron generator 206 may pass through casing without significant attenuation.

The neutron generator 206 may emit a burst of neutrons 246 for a relatively short period of time (e.g., 10 μs or 20 μs, or such) sufficient to substantially only allow for inelastic scattering to take place, referred to herein as a “burst gate.” The burst of neutrons 246 during the burst gate may be distributed through the formation 242, the extent of which may vary depending upon the fast neutron transport of the formation 242. For some formations 242, counts of neutrons 246 obtained by the neutron detectors 212, 214, 216A, and/or 216B generally may accurately reflect the neutron transport of such formations 242. However, for other formations 242 such as formations with light or heavy elements, an additional correction based on a direct measure of neutron flux may be used to more accurately account for the fast neutron transport of the formations 242.

Many of the fast neutrons 246 emitted by the neutron generator 206 may inelastically scatter 248 against some of the elements of the formation 242. This inelastic scattering 248 may produce inelastic gamma rays 250, which may be detected by the gamma ray detectors 218 and/or 220. By determining a formation density by taking a ratio of inelastic gamma rays 250 detected using the two gamma ray detectors 218 and 220 at different spacings from the neutron generator 206, lithology effects may be mostly eliminated.

From count rates of the inelastic gamma rays 250, one or more count rates of neutrons 246, and a determination of the neutron output of the neutron generator 206 via the neutron monitor 208, the data processing circuitry 200 may determine an electron density ρ_{electron} of the formation 242. In general, the electron density ρ_{electron} may be calculated according to a relationship that involves a function of a net inelastic count rate CR_{y}^{inel}, corrected by a neutron transport correction based on a direct measure of neutron flux and a downhole tool calibration correction, which may be functions of one or more neutron count rate(s) CRₙₑᵤₜᵣₒₙ and the neutron output N_{S} of the neutron generator 206, respectively. For example, the electron density ρ_{electron} calculation may take the following form:

$$\frac{log ( {CR}_{γ}^{inel} ) - f ( {CR}_{neutron} ) - log ( {C}_{cal} \cdot {N}_{S} )}{{c}_{1}} = {ρ}_{electron} , \qquad ( 1 )$$

where CR_{y}^{inel} is the net inelastic gamma ray count rate (i.e. the gamma ray count rate after subtraction of gamma rays arising from thermal and epithermal neutron capture), CRₙₑᵤₜᵣₒₙ represents a count rate of neutrons 246 from the fast neutron detector 214, ƒ(CRₙₑᵤₜᵣₒₙ) represents a neutron transport correction, which may be a simple function of the count rate of neutrons 246 that can correct for the fast neutron transport of the formation 242 based on a directly measured neutron flux, C_{cal} is a calibration constant determined experimentally using measurements in test formations of known composition, porosity and density, and N_{S} is the neutron output of the neutron generator 206. The coefficient c₁ may be determined through characterization measurements and nuclear modeling.

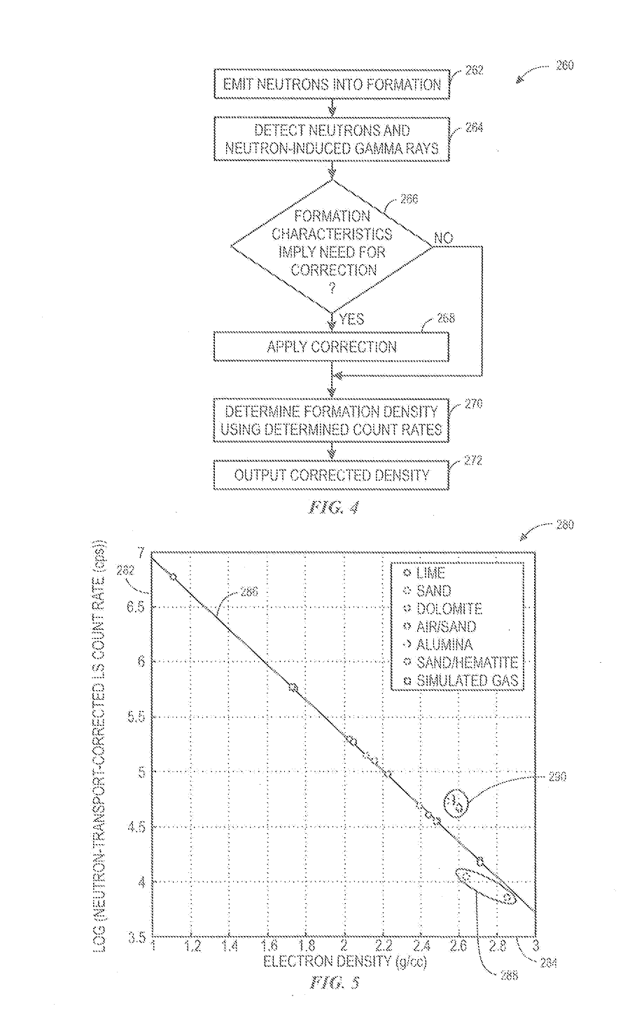

For some formations 242, Equation (1) may result in an accurate density measurement. However, for other formations including formations 242 with relatively high concentrations of light or heavy elements (e.g., formations 242 having concentrations of light or heavy elements that may cause an NGD measurement to be inaccurate without additional correction), the neutron count rate from one or more of the neutron detectors 212, 214, 216A, and/or 216B is believed not to adequately account for the fast neutron transport of such formations 242. Thus, when an NGD measurement is being determined for such formations 242, the count rate of inelastic gamma rays CR_{y}^{inel}, and/or the neutron transport correction function ƒ(CRₙₑᵤₜᵣₒₙ) may be corrected, as described by a flowchart 260 of FIG. 4.

The flowchart 260 of FIG. 4 represents one embodiment of a method for carrying out the well-logging operation 240 of FIG. 3. While the LWD module 120 is in the borehole 244, the neutron generator 206 may emit a burst of neutrons 246 into the formation 242 (block 262). The neutrons 246 may inelastically scatter 248 off certain elements of the formation 242, generating inelastic gamma rays 250. Count rate(s) of neutrons 246 as well as count rate(s) of inelastic gamma rays 250 may be obtained (block 264). As discussed above with reference to Equation (1), such count rate(s) of neutrons 246 generally may relate well to the fast neutron transport of the formation 242 for some formations 242 encountered in an oil and/or gas well.

In other formations 242, however, it is believed that the count rate(s) of neutrons 246 and/or the count rate(s) of gamma rays 250 may not adequately account for the neutron transport of such formations 242. Thus, if the data processing circuitry 200 determines that the fast neutron count rate obtained via the fast neutron detector 214 is outside a predetermined range (decision block 266), which indicates that the formation has characteristics that imply need for correction, the data processing circuitry 200 may undertake a suitable correction of the count rate(s) of inelastic gamma rays 250, and/or the neutron transport correction function ƒ(CRₙₑᵤₜᵣₒₙ), or may provide a global correction that applies to some or all of these terms (block 268). That is, it may be understood that modifying any of the terms in the numerator of Equation (1) could change the resulting NGD determination.

Thus, in block 268, the data processing circuitry 200 may undertake any suitable correction of any of the terms of Equation (1), including the introduction of one or more additional correction term(s), that may cause the NGD measurement to be generally accurate for the formation 242. If the data processing circuitry 200 does not determine that the formation 242 has such characteristics (decision block 266), the data processing circuitry 200 may not apply such a correction. In any case, the data processing circuitry 200 may subsequently determine an NGD measurement of the formation 242 using the determined count rate(s) of neutrons 246, as well as the (corrected or uncorrected) count rate(s) of inelastic gamma rays 250, and/or the neutron transport correction function ƒ(CRₙₑᵤₜᵣₒₙ) (block 270), and output the corrected density (block 272). By way of example, the data processing circuitry 200 may determine the NGD measurement based on the relationship represented by Equation (1).

As mentioned above, although an NGD measurement such as determined using Equation (1) may accurately represent a density measurement for some formations 242, such an NGD measurement may not be accurate for other formations 242 such as formations having a relatively high concentration of light or heavy elements. This effect is apparent FIG. 5, which represents a crossplot 280 modeling the known density of a variety of types of formations 242 against an NGD measurement for the formations 242 obtained using Equation (1) for which, for example, the count rate(s) of inelastic gamma rays 250, and/or the neutron transport correction function ƒ(CRₙₑᵤₜᵣₒₙ) have not been corrected in the presence of, for example, a high concentration of light or heavy elements. In the crossplot 280, an ordinate 282 represents the logarithm of a neutron-transport-corrected gamma ray count rate as detected by the LS gamma ray detector 218, and an abscissa 284 represents electron density of the formation 242 in units of g/cc. A legend indicates various types of formations 242 that have been modeled in the crossplot 280, including limestone, sandstone, dolomite, sandstone with air-filled pores, alumina, sandstone with hematite, and simulated gas. A line 286 represents an accurate correlation between the neutron-transport-corrected gamma ray count rate and the known formation density.

As seen in the crossplot 280, for certain formations 242, despite variations in the densities of the formations 242, the calculated logarithm of neutron-transport-corrected gamma ray count rates lies along the line 286 and accurately corresponds to the known density. These points represent the general accuracy of the NGD determination for these formations 242. However, for formations 242 that have light 288 or heavy elements 290, the calculated logarithm of neutron-transport-corrected gamma ray count rates lies below and above the line 286, respectively. Since the calculated logarithm of neutron-transport-corrected gamma ray count rates of these formations 242 with light 288 or heavy elements 290 does not follow the same function of change with density as the other formations 242 (not falling along the line 286), NGD measurements for the light element formations 288 or heavy element formations 290 obtained using the same (uncorrected) calculations as the other formations 242 may be inaccurate.

It is believed that insufficient fast neutron transport correction may be responsible for the inaccurate calculations for these formations with light or heavy elements 290. Neutron transport corrections can be obtained by modifying, for example, the count rate(s) of inelastic gamma rays 250 and/or the neutron transport correction function ƒ(CRₙₑᵤₜᵣₒₙ) in a suitable manner, such that the calculated logarithm of neutron-transport-corrected gamma ray count rates of the formations 242 that have light elements 288 or heavy elements 290 are shifted to their proper placement along the line 286.

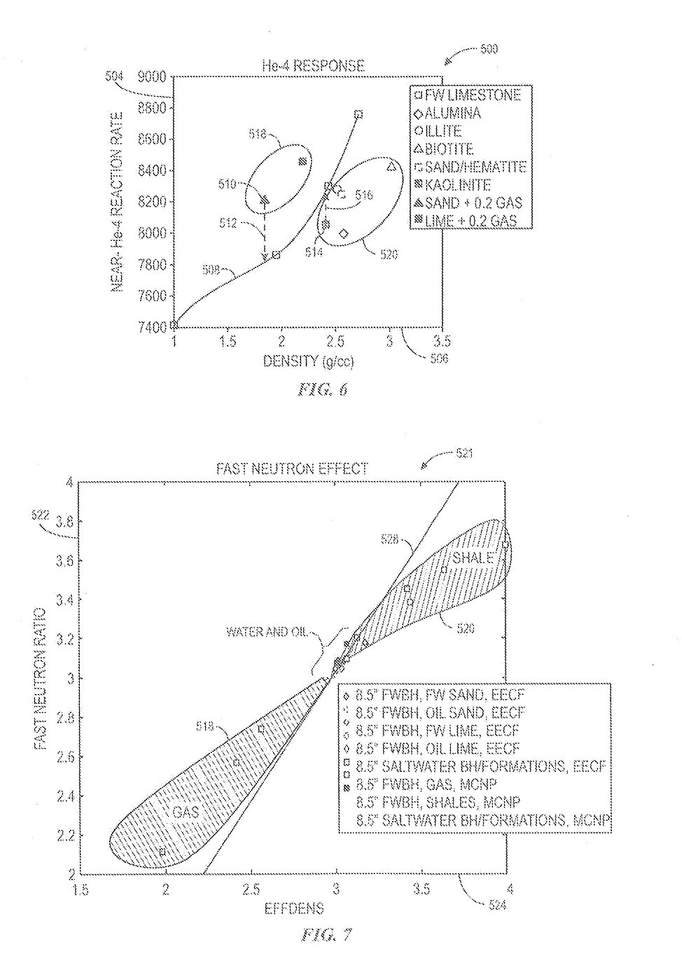

The correction to the count rate(s) of inelastic gamma rays 250, and/or the neutron transport correction function ƒ(CRₙₑᵤₜᵣₒₙ) that is applied in block 268 of FIG. 4 may depend on the direct measurement of the fast neutron signal. The relationship between the direct measurement of the fast neutron signal and the formations with heavy elements 290 may generally be apparent, as provided in a plot 500 in FIG. 6.

In the plot 500 of FIG. 6, an ordinate 504 represents a He-4 reaction rate (response) for the fast neutron detector 214, and an abscissa 506 represents the electron density of the formations 242, as determined by the Equation (1), in units of g/cc. A legend indicates various types of formations 242 that have been modeled in the plot 500, including freshwater filled limestone, alumina, illite, biotite, sand/hematite, kaolinite, sandstone with gas-filled pores, and limestone with gas-filled pores. Situated along a line 508 are the results for formations 242 of freshwater filled limestone, while the collection of points indicated in the plot 500 are associated with the other formations 242 indicated in the legend. Further, line 508 serves as a reference line regarding the application or not of the correction.

The plot 500 provides a clear separation of gas responses 518 (e.g., formation containing light elements) and shale responses 520 (e.g., formation containing heavy elements) to the He-4 reaction rate. That is, the gas responses 518 fall above the line 508 and the shale responses 520 fall below the line 508.

Such a plot may be used in the method represented by the flowchart 260. Accordingly, determining whether a correction is applied (block 266) may include determining a non-corrected density with Equation (1) based on a non-corrected inelastic gamma-ray count rate and/or a neutron transport function, and comparing the measured value with an expected value (as given by the reference line 508) for the determined non-corrected density. It may be determined that the correction is applied if the difference between the measured value and the expected value is outside a predetermined range. Gas responses 518 and shale responses 520 generally result in the application of the correction, as described in detail above.

Using the plot 500, the correction factors of the responses 518 and 520 are determined (block 268) using a vertical distance between a point on the plot 500 and the line 508. Indeed, the vertical distance corresponds to the difference between a measured value of the fast neutron count rate and an expected value of the fast neutron count rate for a formation that is expected to cause the count rate of neutrons to result in an inaccurate neutron gamma density determination (e.g., a value falling on the line). Accordingly, the difference between the measured value of the fast neutron count rate and the expected value of the fast neutron count rate may be an input of a correction function for determining the correction factor.

For example, the correction factor for a sandstone formation with gas-filled pores 510 may be determined using a vertical distance 512 from the formation 510 to the line 508. Similarly, the correction factor for a kaolinite formation 514 may be determined using a vertical distance 516 for the formation 514 to reach the line 508. The vertical distances 512 and 516 may be positive or negative. The correction factors determined via the vertical distances 512 and 516 may be applied to correct the inelastic gamma ray count rate and the neutron transport function. Subsequently, the NGD measurement represented by Equation (1) is corrected (block 270) to remove any fast neutron transport effects, which are generally prevalent in shales containing high concentrations of iron, aluminum, or other heavy elements, or in gases containing high concentrations of light elements.

The functions described by blocks 266, 268, and 270 may be performed iteratively, with the density that was corrected in a previous iteration is used in the current iteration for determining whether the correction is needed. The method may stop when a determination is made that correction is not needed (e.g., at an iteration (n+1) when the difference between the measured value of the fast neutron count rate and the expected value for the corrected density is in a predetermined range). The density output at block 272 is then the density determined at the n^{th} iteration.

Using a He-4 fast neutron detector in place of other non-fast neutron detectors may provide several advantages. As discussed in more detail below, the He-4 fast neutron detector provides a reduction in complexity of the physics used for determining the correction factors. That is, the He-4 fast neutron detector provides a direct measurement of the fast neutron flux instead of a complicated algorithm for predicting the fast neutron flux. Additionally, the He-4 fast neutron detector may have a greater dynamic range than other neutron detectors. Additionally, there is a greater statistical precision associated with the correction factors than the precision of correction factors calculated based on other neutron detectors.

In a plot 521 of FIG. 7, which plots data using neutron detectors other than fast neutron detectors (e.g., other than an He-4 fast neutron detector), correction factors for gas responses 518 and shale responses 520 are again calculated using the vertical distance between a point on the plot 521 and a line 520 representing water and oil-filled formations 242. However, in the plot 521 of FIG. 7, an ordinate 522 representing a fast neutron ratio and an abscissa 524 representing an effective density in g/cc are each calculated using complicated functions of multiple detector responses. For example, functions used to determine the effective density and the fast neutron ratio may include many different inputs. Accordingly, the effective density and the fast neutron ratio are difficult to determine and parameterize even using both measured and simulated data. Because of this, the points on the plot 521 are determined with greater computation costs than the direct measurements achieved using the fast neutron detector 214.

Technical effects of the present disclosure include the accurate determination of a neutron-gamma density (NGD) measurement for a broad range of formations, including formations with light or heavy elements. These NGD measurements may remain accurate even when the configurations of a downhole tool used to obtain the neutron count rates and gamma ray count rates used in the NGD measurement do not have optimal configurations. Thus, an accurate NGD measurement may be obtained using the systems and techniques disclosed above.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A method comprising:
emitting neutrons into a formation using a neutron source of a downhole tool, such that at least a portion of the neutrons inelastically scatter off the formation to generate inelastic gamma rays;
detecting a count rate of inelastic gamma rays using a gamma ray detector of the downhole tool;
directly measuring a fast neutron signal with a fast neutron detector of the downhole tool that determines a count rate of fast neutrons, wherein the fast neutron signal varies depending on a neutron transport characteristic of the formation;
determining whether the neutron transport characteristic of the formation is expected to cause the count rate of fast neutrons to result in a neutron gamma density determination that is not accurate without a fast neutron correction, wherein the fast neutron correction is not applied when the neutron transport characteristic is not expected to cause the count rate of fast neutrons to result in the neutron gamma density determination that is not accurate without the fast neutron correction;
when the formation has the neutron transport characteristic that is expected to cause the count rate of fast neutrons to result in the neutron gamma density determination that is not accurate without the fast neutron correction:
applying the fast neutron correction to the count rate of inelastic gamma rays, a neutron transport correction function, or both;
determining a density of the formation based at least in part on a corrected count rate of inelastic gamma rays, corrected neutron transport correction function, or both; and
outputting the determined density of the formation.

2. The method of claim 1, wherein the fast neutron detector comprises a He-4 fast neutron detector.

3. The method of claim 1, wherein determining whether the neutron transport characteristic of the formation is expected to cause the count rate of fast neutrons to result in the neutron gamma density determination that is not accurate without the fast neutron correction comprises determining whether the formation comprises a concentration of light or heavy elements beyond a predetermined threshold.

4. The method of claim 1, wherein determining whether the neutron transport characteristic of the formation is expected to cause the count rate of fast neutrons to result in the neutron gamma density determination that is not accurate without the fast neutron correction comprises determining whether a measured value of the fast neutron count rate is outside a predetermined range.

5. The method of the preceding claim, wherein determining whether the measured fast neutron count rate is outside the predetermined range comprises:
determining a non-corrected density based on a non-corrected measured count rate of inelastic gamma rays and a non-corrected neutron transport correction function; and
comparing the measured value of the fast neutron count rate to an expected value of the fast neutron count rate of a formation having the non-corrected density that is expected to cause the count rate of fast neutrons to result in the neutron gamma density determination that is accurate.

6. The method of the preceding claim, wherein applying the fast neutron correction comprises using a correction function depending on the difference between the measured value of the fast neutron count rate and the expected value of fast neutron count rate.

7. The method of the preceding claim, wherein applying the fast neutron correction comprises:
determining the difference between the measured value of the fast neutron count rate and the expected value of the fast neutron count rate; and
determining a correction factor based on the correction function and the determined difference, and correcting with the correction factor the count rate of inelastic gamma rays, the neutron transport correction function, or both.

8. The method of claim 1, wherein the method comprises performing iteratively:
determining whether the neutron transport characteristic of the formation is expected to cause the count rate of fast neutrons to result in the neutron gamma density determination that is not accurate without the fast neutron correction,
when the formation has the neutron transport characteristic that is expected to cause the count rate of fast neutrons to result in the neutron gamma density determination that is not accurate without the fast neutron correction:
applying the fast neutron correction to the count rate of an inelastic gamma rays, a neutron transport correction function, or both;
determining a density of the formation based at least in part on the corrected count rate of inelastic gamma rays, the neutron transport correction function, or both;
wherein an n^{th} corrected density determined from an n^{th} iteration is used to determine whether the neutron gamma density is accurate in an (n+1)^{th} iteration, and wherein outputting the determined density comprises outputting the density determined at the n^{th} iteration.

9. The method of claim 1, wherein when the neutron transport characteristic is not expected to cause the count rate of fast neutrons to result in the neutron gamma density determination that is not accurate without the fast neutron correction, determining the density of the formation is based at least in part on the count rate of inelastic gamma rays without correction, a neutron transport function without correction, or both.

10. The method of claim 1, wherein the density of the formation is determined at least based on the inelastic gamma-ray count rate, the fast neutron count rate, and the neutron transport function.

11. The method of the preceding claim, wherein the density of the formation is determined based at least in part on the following relationship:
$$\frac{log ( {CR}_{γ}^{inel} ) - f ( {CR}_{neutron} ) - log ( {C}_{cal} \cdot {N}_{S} )}{{c}_{1}} = {ρ}_{electron} ,$$
where ρ_{electron} represents the density of the formation, CR_{y}^{inel} represents the count rate of inelastic gamma rays, CRₙₑᵤₜᵣₒₙ represents the count rate of fast neutrons, ƒ(CRₙₑᵤₜᵣₒₙ) represents the neutron transport correction function, C_{cal} represents a calibration constant, N_{S} represents an output of the neutron source, and c₁ represents a coefficient obtained experimentally or through nuclear modeling, or by a combination thereof.

12. A downhole tool comprising:
a neutron source configured to emit neutrons into a formation at an energy sufficient to cause at least a portion of the neutrons to inelastically scatter off elements of the formation, generating inelastic gamma rays;
a gamma ray detector configured to detect a count rate of inelastic gamma rays that scatter through the formation to reach the downhole tool;
a fast neutron detector that determines a count rate of fast neutrons, wherein the fast neutron detector is configured to directly measure a fast neutron signal that varies depending on a fast neutron transport characteristic of the formation; and
data processing circuitry configured to:
determine whether the neutron transport characteristic of the formation is expected to cause the second count rate of fast neutrons to result in a neutron gamma density determination that is not accurate without a fast neutron correction, wherein the fast neutron correction is not applied when the neutron transport characteristic is not expected to cause the count rate of neutrons to result in the neutron gamma density determination that is not accurate without the fast neutron correction;
when the formation has the neutron transport characteristic that is expected to cause the count rate of neutrons to result in the neutron gamma density determination that is not accurate without the fast neutron correction the data processing circuitry is configured to:
apply the fast neutron correction to the count rate of inelastic gamma rays, a neutron transport correction function, or both;
determine a density of the formation based at least in part on a corrected count rate of inelastic gamma rays, corrected neutron transport correction function, or both; and
output the determined density of the formation.

13. The downhole tool of claim 12, wherein the fast neutron detector comprises a He-4 fast neutron detector.

14. The downhole tool of claim 12, wherein the neutron source is a pulsed neutron generator.

15. The downhole tool of claim 9, comprising a logging while drilling configuration.
